(19) United States
(12) Patent Application Publication
(10) Pub. No.: US 2002/0035522 A1
(43) Pub. Date: Mar. 21, 2002

(54) Method of providing an inventory of digital images and product

(76) Inventor: Al Pilcher, Ottawa (CA)

Correspondence Address: Killworth, Gottman, Hagan & Schaeff, L.L.P., One Dayton Centre, Suite 500, Dayton, OH, 45402-2023, US

(21) Appl. No.: 09/852,928

(22) Filed: May 10, 2001

Related U.S. Application Data
(60) Provisional application No. 60/224,005, filed on Aug. 1, 2000.

(30) Foreign Application Priority Data
May 12, 2000 (CA) 2,308,830

(51) Int. Cl. G06F 17/60

(52) U.S. Cl. 705/28

(57) ABSTRACT

The invention is directed to a method of providing an inventory of digital images and a computer storage medium product for providing a fixed record of the inventory. The inventory represents items found within a household, a business and/or a collection that are grouped into rooms and/or areas and/or categories. The method comprises acquiring digital images of the items for the inventory, transferring the images to a computer memory, formatting the images in the computer, encrypting the formatted images, applying a personal identification number (PIN) or password to the encrypted images and transferring the encrypted formatted images to a storage medium. The images taken by a camera may be transferred to the computer memory by direct coupling or a wireless link. All image files are then deleted from the camera memory and the computer memory. The storage medium product may be a CD-ROM or a secured server memory having data that comprises a number of room/area/category folders for storage of inventory images from corresponding rooms/area/categories, a thumb print folder within each of the room/area/category folders for storage of corresponding thumb print images and a viewer folder for storing files for viewing the images. The data may further include decryption files for decrypting the images stored in the folders.

### CROSS REFERENCE TO RELATED APPLICATIONS

This application claims the benefit of U.S. Provisional Patent Application Serial No. 60/ 224,005 filed on Aug. 1, 2000, which claims the benefit of Canadian Patent Application 2,308,830 filed on May 12, 2000.

### BACKGROUND OF THE INVENTION

The invention relates generally to the preparation of an inventory and more particularly to producing an inventory of digital images.

It is highly recommended by insurance companies that an inventories of all of the contents of a room, an apartment, a home, a business or some other unit be maintained as a way of identifying exactly what has been lost when filing an insurance claim after a burglary, theft, fire, flood, storm or some other disaster. Insurance companies require that a list of the items lost be provided to them with any claim; the availability of a complete inventory helps to accelerate the settlement of claims. When a list is being prepared after a loss, often items are simply forgotten. When an inventory exists before the loss, it is satisfying to know that, at these times of stress, all items that have been lost can be identified. Some insurance companies consider that the maintenance of such an inventory is so beneficial to them in settling claims that they even consider reducing their insurance premiums to encourage their clients to prepare them in advance.

In addition, such inventories have also been found to be helpful in determining the value of one's personal property at the time that insurance is being purchased since it is easy to underestimate the true value of personal property if it is not looked at in detail. Police reports regarding thefts also need as much description as possible of the articles that have been stolen in order to be able to identify them when they are found.

In households, the inventories should include not only the items that can be seen when entering an area or a room, but also items stored in closets, cabinets and drawers, as well as the attic, shed, garage and exterior of the home. It is particularly important to include valuable items such as jewelry, artwork, furs, coins, silverware and guns.

It is often also desirable to have such an inventory, in situations where a property is to be rented or sold, or when personal property is being moved or placed in storage. In time-shares and other such rental properties, an inventory of the contents of the premises must be reviewed by the renter on entry and by the proprietor when the renter leaves. This is a tedious task since the inventory is usually a textual one and the renter who is not familiar with the property, must seek out each and every item in order to avoid charges for missing items. When a property is to be sold and an initial estimate of the value of the contents is required, a written inventory is cumbersome and time consuming, and generally many items are neglected during the process. This is also true when property is being moved or stored for long periods of time. It is particularly useful to have on hand a visual inventory that can be consulted quickly and effectively.

In order to resolve the above problem, the contents of dwellings or businesses have been taped for future reference using VCR's or 8 mm cameras. These arrangements have a number of disadvantages, the primary being that is difficult to access specific images quickly and then to print off hard copies. With videotape, it is difficult to see the images, since the VCR must be paused, creating distortions, which can make the image difficult to interpret.

Therefore, there is a need for a method of producing a visual inventory of an establishment such that the inventory is readily accessible by the client.

### SUMMARY OF THE INVENTION

The invention is directed to a method of providing an inventory of digital images and a computer storage medium product for providing a fixed record of the inventory. The images in the inventory represent the items found within a household, a business and/or a collection and are generally grouped by rooms and/or areas and/or categories. The method for providing the inventory comprises acquiring digital images of the items for the inventory, transferring the images to a computer memory, formatting the images in the computer, encrypting the formatted images, applying a personal identification number (PIN) or password to the encrypted images and transferring the formatted images to a storage medium.

In accordance with an aspect of this invention, the images may be acquired by taking the digital images of the items with a digital camera and storing the digital images in a temporary memory in the camera. The digital images may then be transferred from the temporary memory by connecting it to the computer. The images would then be deleted from the temporary memory. Alternately, the digital images of the items may be taken with a digital camera and transmitted from the digital camera to the computer over a wireless link.

With regard to a further aspect of the invention, the images may be acquired by taking the digital images of the inventory items with a digital camera, generating thumb print images in the camera corresponding to the inventory images, storing the inventory images in a folder in a temporary memory in the camera and storing the corresponding thumb print images in a folder within the inventory folder. The temporary memory may then be connected to the computer to transfer the inventory images and the thumb print images to it after which the images are cleared from the temporary memory. Alternatively, the inventory images may be stored in inventory folders in the computer memory. Thumb print images corresponding to the inventory images may then be generated within the computer and stored in a folder within the inventory folder.

In accordance with another aspect of this invention, the storage medium may be a CD-ROM or a secured server memory. In addition, all of the encrypted formatted images may then be deleted from the computer memory.

With regard to another aspect of the present invention, the computer storage medium product provides a fixed record of the inventory images as generated by one of the above methods. The data comprises a number of room/area/category folders for storage of inventory images from corresponding rooms/areas/categories, a thumb print folder within each of the room/area/category folders for storage of corresponding thumb print images, and a viewer folder for storing files viewing the images. The data may further include decryption flies for decrypting the images stored in the folders. The viewing files may be html files.

Other aspects and advantages of the invention, as well as the structure and operation of various embodiments of the invention, will become apparent to those ordinarily skilled in the art upon review of the following description of the invention in conjunction with the accompanying drawings.

### BRIEF DESCRIPTION OF THE DRAWINGS

The invention will be described with reference to the accompanying drawings, wherein:

FIG. 1 is a schematic diagram of the apparatus used to implement the present invention;

FIG. 2 illustrates a flow chart of the method in accordance with the present invention;

FIG. 3 shows the visual format of the first page of the inventory;

FIG. 4 shows the visual format of thumb print images for a room or an area;

FIG. 5 shows the visual format of a large image selected from the thumb print images in FIG. 4;

FIG. 6 shows the inventory folders and files on the CD-ROM product;

FIG. 7 shows the files in the html folder in FIG. 6;

FIG. 8 shows the graphics files in the graphics folder in FIG. 7;

FIG. 9 shows the image tiles in a typical room/area/category folder in FIG. 6; and

FIG. 10 shows the thumb print files in the room/area/category folder in FIG. 9.

### DETAILED DESCRIPTION OF THE INVENTION

The method of producing a visual inventory and the product itself in accordance with the present invention will have a number of applications related to either residential or commercial establishments.

In a residential application, it is usually necessary to produce an inventory of the contents of all of the rooms of a home. This generally consists of the furniture, the household appliances, kitchen equipment, art and other decorative items, as well as personal effects including jewelry. For insurance purposes, particularly for replacement value of property, it may also be desirable to include construction details of the inside and the outside of the house as well as other structures on the property such as the garage, shed, pool and landscaping. The inventory would therefore generally list images on a room-by-room basis followed by other categories such as a shed and landscaping

In a commercial application, it is often the case that there are a number of major buildings in a business; these may be co-located on one site or dispersed over a number of sites. Thus, the commercial establishment inventory might be hierarchically organized by country, by city, by site, by building and by area within each building. The contents to be inventoried would depend on the business itself and what the client deems to be important to the business.

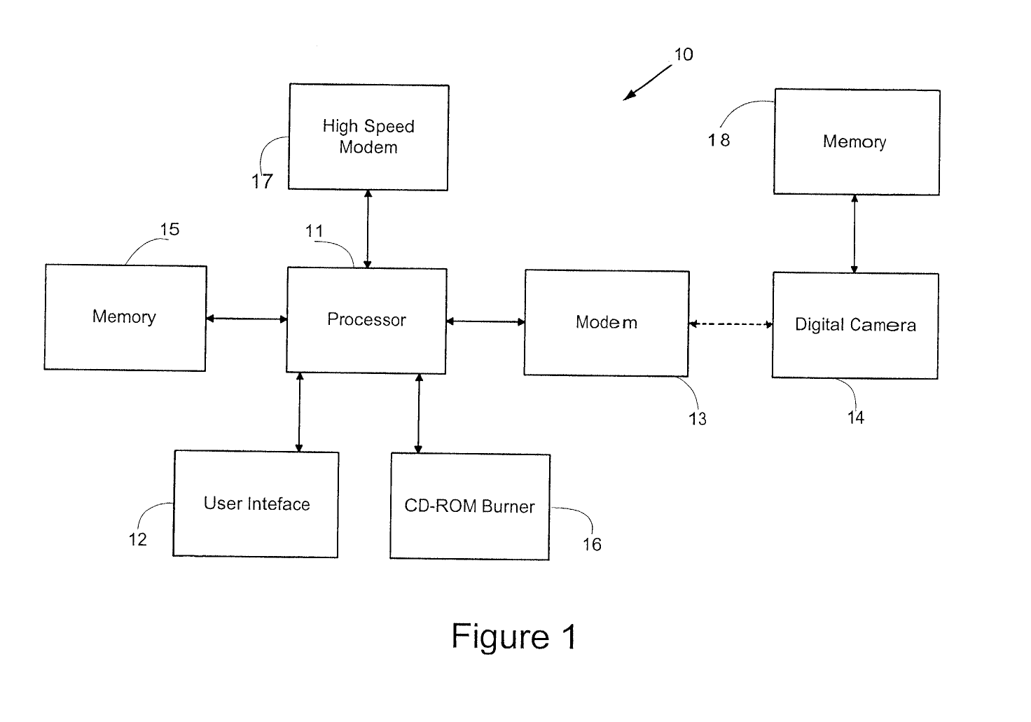

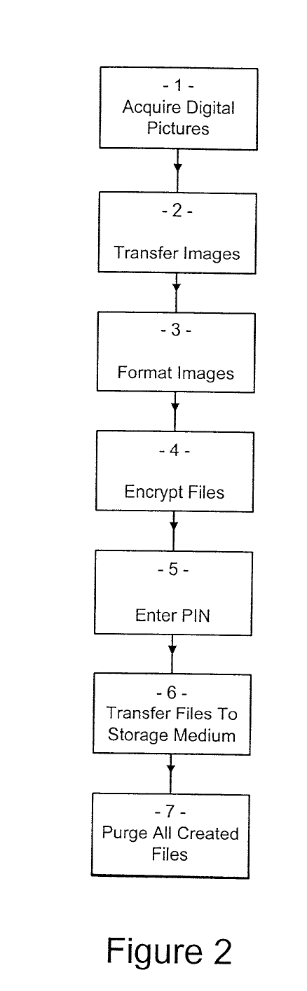

The method of producing the visual inventory in accordance with the present invention is carried out on an apparatus as schematically illustrated in FIG. 1. The method will be described in conjunction with the flow chart in FIG. 2. The apparatus 10 includes a processor 11 connected to a riser interface 12 and a modem 13. The modem acts as a communications link to a digital camera 14 which has a short-term memory 18 coupled to it. The short-term storage medium may be a 3.5-inch disk, flashcard, memory stick, palm pilot, or some other similar memory that can easily be associated with the digital camera 14. The communications link may be hard wired or wireless such as a RF or infrared system. A wireless system based on the Bluetooth protocol would be an effective communications link. The apparatus 10 further includes a memory 15 associated with the processor 11, as well as a CD-ROM writer 16 and optionally a high-speed modem 17 for transmission to a web server. The present embodiment is described in conjunction with the use of a CD-ROM, however other portable memory mediums may also be used. The apparatus 10 would preferably take the form of a laptop computer for the convenience and the security of implementing the method on site at a client's home or the business.

The present method will be described with respect to a household application, however it is understood it is equally applicable to all other applications where the production of a visual inventory is needed or desired such as a business or a manufacture. Step I consists of taking digital pictures of the contents of the household. Using the digital camera 14 as many images as are necessary to capture all items are taken on a room-by-room, area-by-area and category basis. In the rooms, these include items inside cupboards, drawers, and closets. These digital images are stored on the short-term storage medium 18 which in this particular embodiment includes 3.5-inch disks.

In step 2, the digital images are transferred from the digital camera 14 short-term storage medium 18 through modem 13 and processor 11 to the processor memory 15 which would normally be a bard drive in the laptop. This step, which is controlled by software in the processor 11, may be done in a number of ways, however in all cases after the images are transferred from the camera's 14 short-term storage medium 18, they are also completely deleted from the short-term storage medium 18. This programmed deletion allows the short-term storage medium 18 to be reused and adds to the security of the client's property by reassuring the client that their image files will not be used for other purposes.

During this transfer, a file structure is also created. In the present embodiment, the file structure comprises a directory with a text file identifying the title of the inventory such as a client's name or the name of the client company. The directory further includes a number of room/area/category folders, each of which is used to store the full size inventory images from one room, area or category. The room/area/category folders each include a thumb print folder that is used to store the thumb print images corresponding to the full size inventory images in the respective room/area/category folder. The inventory images are labeled according to room/area/category folder in which they are stored, and each thumb print image is labeled so as to be associated with its corresponding inventory image.

Some digital cameras, such as the Sony MVC-FD91 provide full size images as well as the corresponding thumb print image. When such a camera is used, both images are transferred through the processor 11 to memory 15 and placed in the appropriate folders. In the situation where the camera only produces the full size image, the processor 11 generates the corresponding thumb print image and stores both images in the appropriate folders in memory 15.

All of the images for a project may be taken before a transfer takes place, or they may be taken and transferred on a room-by-room basis. For convenience and efficiency, the images for each room/area/category would be stored on one or more separate memory disks 18. In this way, each disk 18 can be programmed with the identity of the room/area/category in which the images were taken. The processor 11 can then recognize the name of the room/area/category, create a folder by that name under the directory, recover the inventory images and the corresponding thumb print images, if they exist, from the disk 18, sequentially name and place the inventory images in the created room/area/category folder and place the existent or generated thumb print images into the corresponding thumb print folder under the room/area/category folder, and then erase the images from the disk 18. If a wireless communication link is used between the digital camera 14 and the processor 11 through the modem 13, the digital images are received by the processor 11 substantially as they are being taken. In such a process, the digital camera 14 may require a buffer to temporarily store an image as it is being taken depending on the speed of the wireless transmission. Wireless transmission of images would allow image processing to take place in parallel to the image taking. In this arrangement, the operator would be required to identify the room/area/category in which the images are to be taken in advance so that the processor 11 can place them in the sequence they are received in a properly named room/area/category folder in memory 15.

In either communication arrangement, further images may be taken and added to the room/area/category folders in sequence to the images already in the folders. However, care must be taken to direct the transfer of the newly taken images to the proper folders.

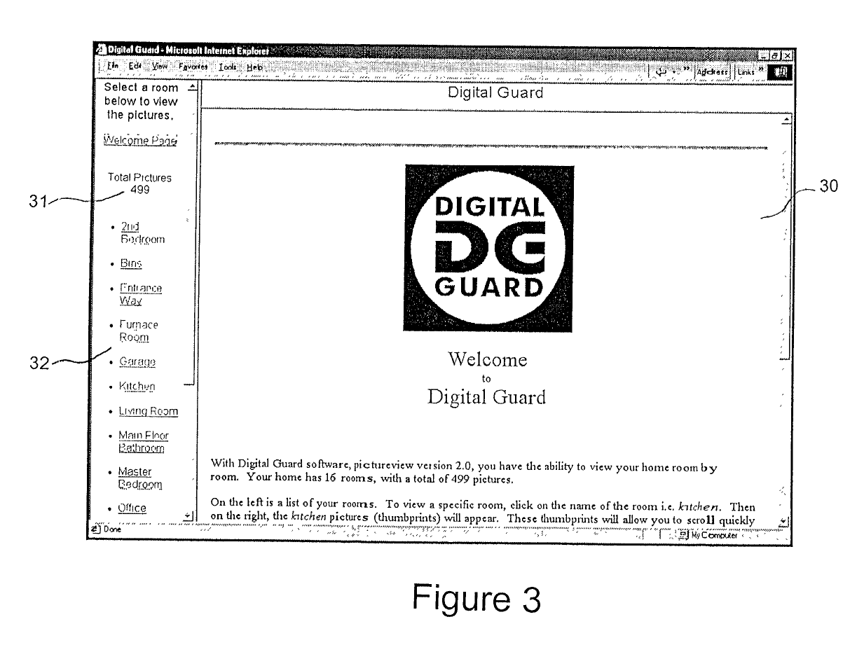

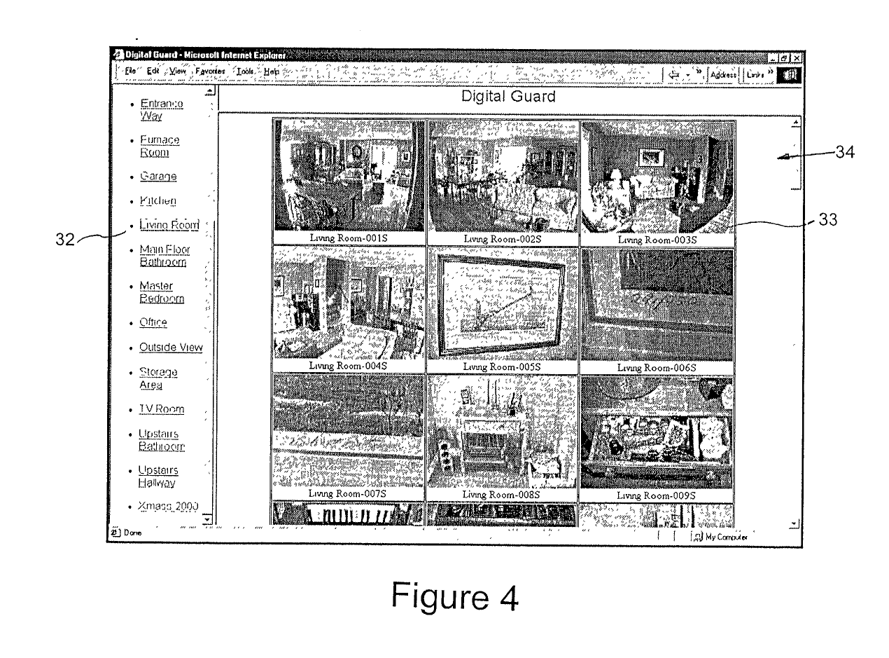

In step 3, builder software in the processor 11 is initiated to produce the format structure by which the images can be readily viewed. In this particular embodiment, the html format is utilized. The structure includes the first page 30 of the inventory as illustrated in FIG. 3. In addition to basic graphics, the total number 31 of inventory images that the project encompasses is displayed as well as an inventory index or room/area/category listing 32 of the rooms/areas/categories having images. The software further organizes a view in which the thumb print images 33 can be seen in sequential rows 34 with three images in each row as illustrated in FIG. 4. The particular thumb prints 33 brought to the screen are determined by the selection of a particular room/area/category from the index 32. The software may also fill any blank spaces in the rows with logos or some other preselected image. The viewing software further causes a full size inventory image 35 to be displayed on the screen when the corresponding thumb print 33 is selected. Though html viewing software is utilized, other viewing software could equally be used.

In further enhancements of the viewing software, the indexing of individual images may be added as labels to the inventory images so that a specific image can be selected by a specific index code to be viewed rather then by selection of a thumb print image. Additionally, text or voice messages associated with individual images can be added to the files and the first page 30 may include toggles which would activate or deactivate these messages during the viewing of the inventory images.

In step 4, all formatted images and related files for the application are encrypted using a third-party software such as PC Guardian. Once the files are encrypted, the client enters a password or a Personal Identification Number (PIN) with a minimum number of characters, such as five, through the user interface 12 in step 5. Since the client personally enters the PIN, it adds a level of security for the inventory; the PIN protects the encrypted files and therefore only the client is able to view the images.

Since remembering the PIN is so critical in such a case where there is no back door through which a service provider may enter to override the PIN, it is desirable to provide a routine whereby information that provides the client hints regarding the PIN may be entered and saved.

In step 6, all the encrypted formatted digital images and files are transferred onto a storage medium such as a CD-ROM for the client. Also, the decryption software required by the client to open and view the images is also placed on the CD-ROM. If the CD-ROM is left open, further files may be added to it; it is therefore preferred that the CD-ROM be closed-off so no further altering can be performed. This process would be carried out using standard software such as Adaptec Direct CD Wizard 2.5d.

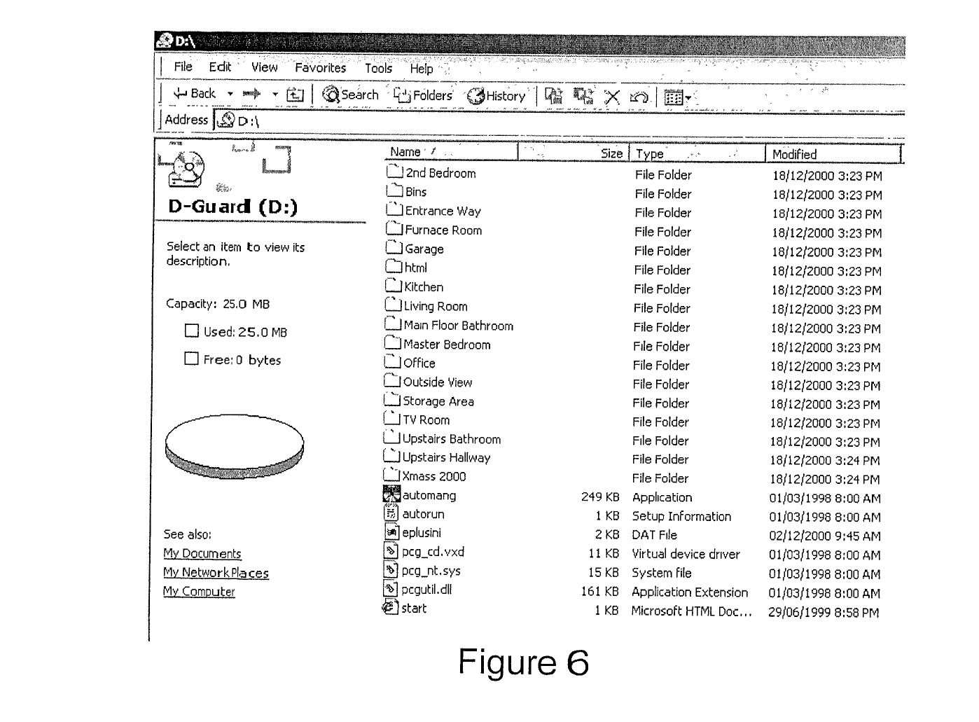

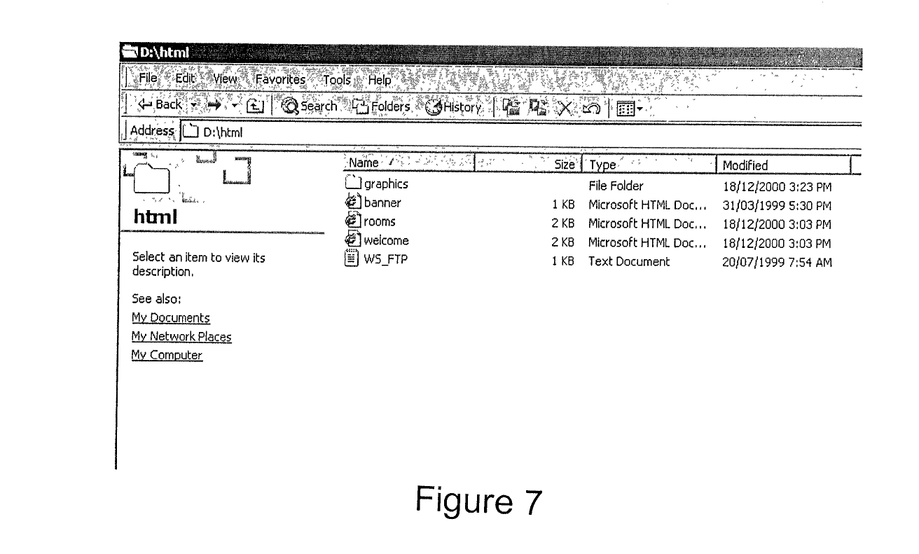

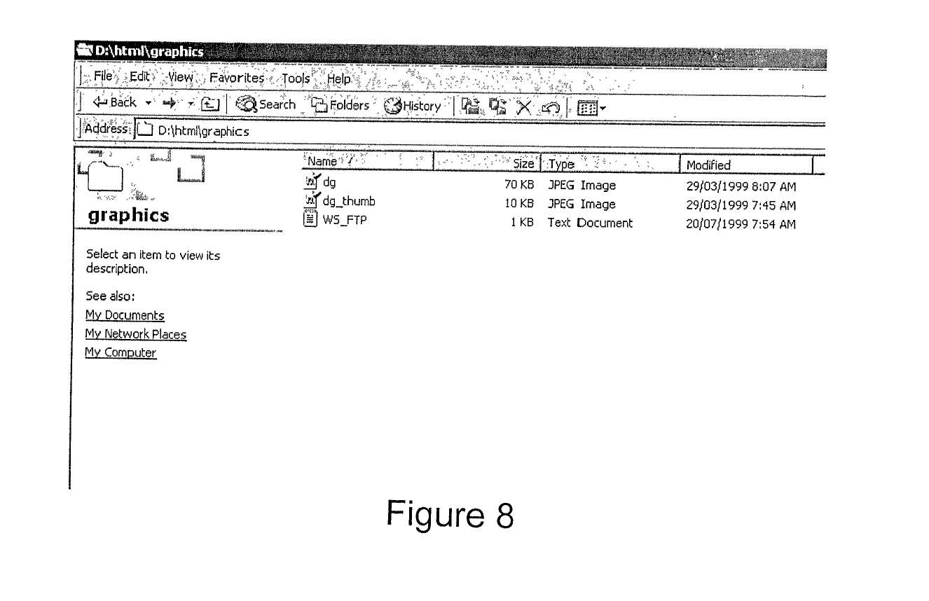

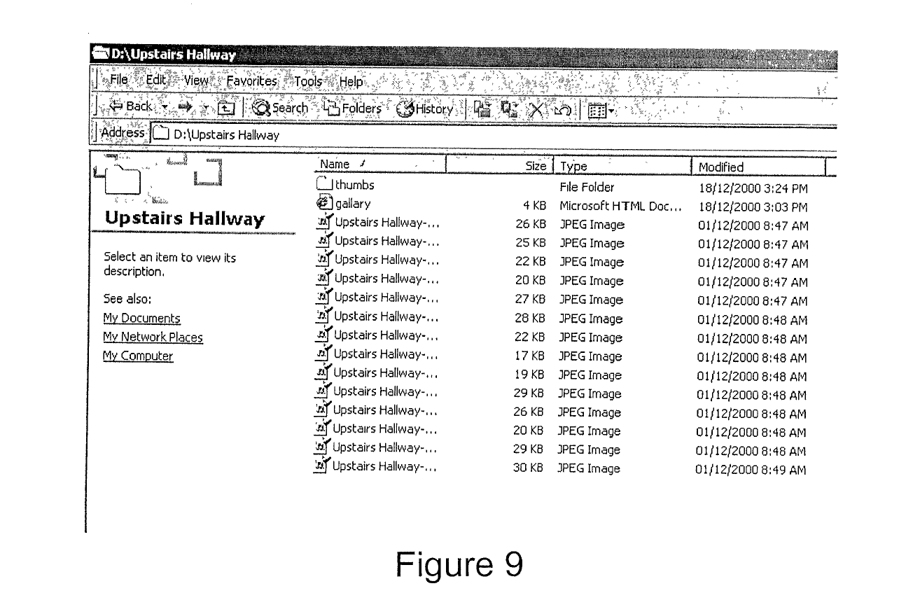

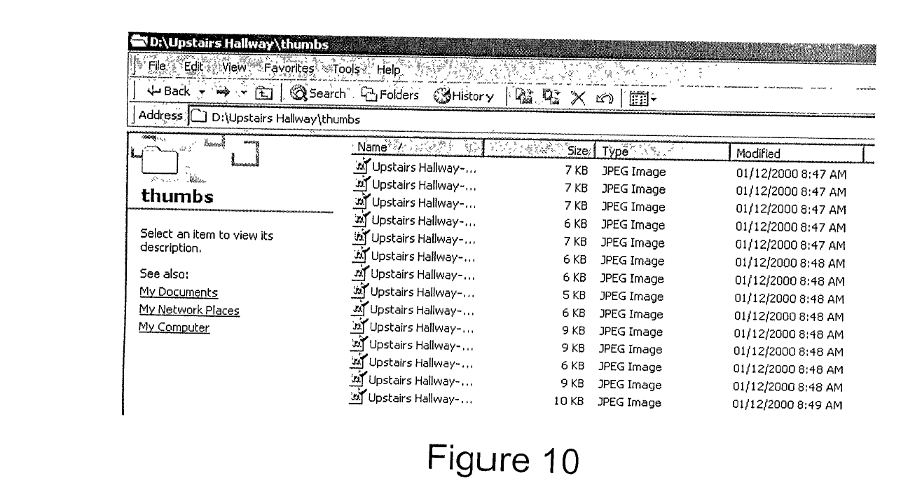

The files on the resulting CD-ROM product are illustrated in FIGS. 6 to 10. FIG. 6 shows a set of room/area/category folders, an html folder as well as a start routine and the decryption software files. However, the decryption software files may be located in memo on the computer used to access the images by the client instead of the CD-ROM. FIG. 7 shows the files in the html folder in FIG. 6. The html folder includes a graphic folder which includes JPEG files and a text file as shown in FIG. 8, as well as html routines and a text file. Each room/area/category folder includes a series of images taken in that particular room/area/category as shown in FIG. 9 of the household being inventoried. Each of room/area/category folders further includes a thumb print folder of corresponding thumb print images and an html file, Finally, the thumb print folder as shown in FIG. 10 includes the thumb print images of the corresponding images shown in FIG. 9. It is to be noted that the inventory images and thumb print images are time stamped as to when they were taken as shown in FIGS. 9 and 10; and in addition, the folders are also date stamped as to when they were created as shown on FIGS. 6 and 9. Furthermore, once closed, the CD-ROM itself cannot be altered.

As an alternate to the CD-ROM storage medium given to the client, web hosting may be utilized where the encrypted and secured images and files may be transferred to a secure site that the client may access through direct communications channels or through the Internet.

Step 7 includes deleting all of the client's images and files from the processor 11 and its memory 15 by deleting the folders and files from the directory and then from the recycle bin As an added precaution, the memory 15 may be defragmented so that the files cannot be recovered. This provides the clients the assurance that they possess the only copies of the images that were taken on their premises. This assurance is strengthened by the fact that the entire process was carried out on the clients own premises.

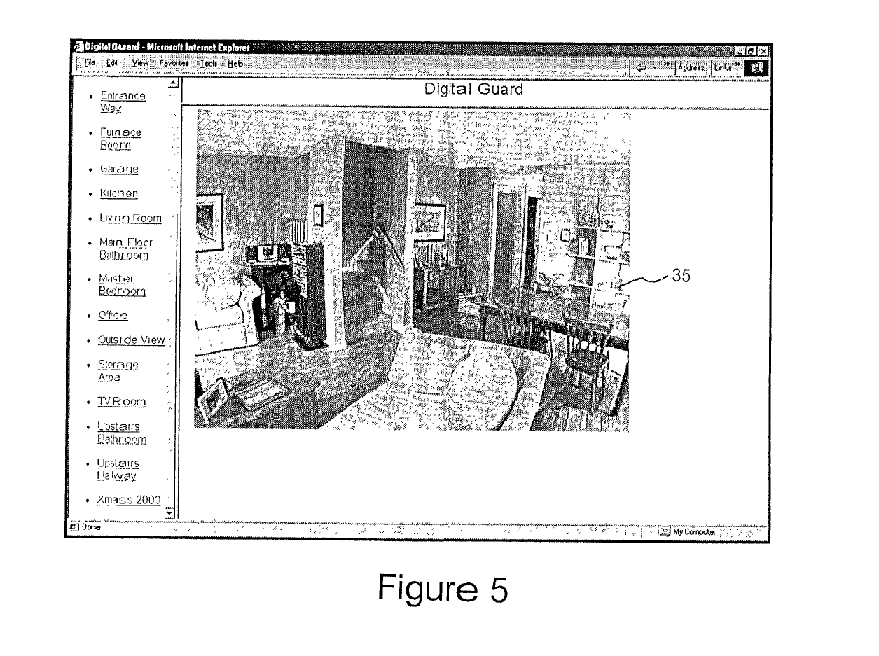

The client may view the images whenever desired on standard computer equipment either at home or at a service provider. On accessing the CD-ROM, the autorun is usually initiated automatically but may be initiated manually if necessary. A block will then pop-up on the screen requesting the PIN or password. This message may be accompanied by a further message providing hints regarding the PIN. In further embodiments, a separate screen may be developed to input these initial messages. The first page 30 as shown in FIG. 3 appears after the PIN is entered. Using the index, the client can select any one of the rooms/areas/categories listed. The thumb print images for that room/area/category appear on the screen in sequential rows of three images as shown in FIG. 4. Selecting one of the thumb print images call up the corresponding inventory image on the screen as shown in FIG. 5 facilitating a closer detailed inspection of it.

The product which results from the above described process has a number of advantages. The inventory is stored on a durable, compact and long-lasting medium. For example, CD-ROM's or other such storage mediums have a life expectancy that exceeds the usefulness of the inventory stored on it. In addition, the client can quickly access and clearly view specific images, and easily print a hard copy.

At any time after the encrypted images and files have been transferred to a memory such as a CD-ROM or a server, the client may have a revised inventory produced using the inventory images of the existing inventory. The existing inventory is opened on the apparatus 10 described with respect to FIG. 1 in the same manner as described above for viewing the inventory. Once open, the permissions are changed so that images can be added and/or deleted from the folders. All original images will retain the date on which they were originally taken, all new images will have the new date on which they were taken, and all of the folders will be show the new date on which the revised inventory was produced. The new CD-ROM on which the revised inventory is stored will reflect these dates.

While the invention has been described according to what is presently considered to be the most practical and preferred embodiments, it must be understood that the invention is not limited to the disclosed embodiments. Those ordinarily skilled in the art will understand that various modifications and equivalent structures and functions may be made without departing from the spirit and scope of the invention as defined in the claims. Therefore, the invention as defined in the claims must be accorded the broadest possible interpretation so as to encompass all such modifications and equivalent structures and functions.

What is claimed is:

1. A method of providing an inventory of digital images comprising the steps of:
acquiring digital images of the items for the inventory;
transferring the images to a computer memory;
formatting the images in the computer;
encrypting the formatted images;
applying a PIN to the encrypted images; and
transferring the formatted images to a storage medium.

2. A method of providing an inventory of digital images of items in predetermined rooms/areas/categories of a household comprising the steps of:
acquiring digital images of the items in each room/area/category of the household for the inventory;
transferring the images to a computer memory;
formatting the images in the computer by areas in the residence;
encrypting the formatted images;
applying a PIN to the encrypted images; and
transferring the encrypted formatted images to a storage medium.

3. A method of providing an inventory of digital images of items in predetermined rooms/areas/categories of a business comprising the steps of:
acquiring digital images of the items in each room/area/category of the building for the inventory;
transferring the images to a computer memory;
formatting the images in the computer by areas of the business;
encrypting the formatted images;
applying a PIN to the encrypted images; and
transferring the encrypted formatted images to a storage medium.

4. A method as claimed in claim 1, further comprising:
taking the digital images of the items with a digital camera; and
storing the digital images in a temporary memory in the camera.

5. A method as claimed in claim 4 further comprising
connecting the temporary memory to the computer to transfer the digital images; and
clearing the digital images from the temporary memory.

6. A method as claimed in claim 1 further comprising:
taking the digital images of the items with a digital camera; and
transmitting the digital images from the temporary memory to the computer over a wireless link.

7. A method as claimed in claim 1 further comprising:
taking the digital images of the inventory items with a digital camera;
generating thumb print images corresponding to the inventory images;
storing the inventory images in a folder in a temporary memory in the camera; and
storing the corresponding thumb print images in a folder within the inventory folder.

8. A method as claimed in claim 7 further comprising:
connecting the temporary memory to the computer to transfer the inventory images and the thumb print images; and
clearing the images from the temporary memory.

9. A method as claimed in claim 1 further comprising:
storing the inventory images in an inventory folder;
generating thumb print images corresponding to the inventory images; and
storing the thumb print images in a folder within the inventory folder.

10. A method as claimed in claim 1, wherein the storage medium is a CD-ROM or a secured server memory.

11. A method as claimed in claim 1, further comprising:
deleting the encrypted formatted images from the computer memory.

12. A computer-readable storage medium containing data for storing the inventory of digital images as produced by the method as claimed in claim 1.

13. A computer readable storage medium as claimed in claim 12 which comprises:
a number of room/area/category folders for storage of inventory images from corresponding rooms/areas/categories;
a thumb print folder within each of the room/area/category folders for storage of corresponding thumb print images; and
a viewer folder for storing files for viewing the images.

14. A computer readable storage medium as claimed in claim 12 which comprises:
a number of room/area/category folders for storage of inventory images from corresponding rooms/areas/categories;
a thumb print folder within each of the room/area/category folders for storage of corresponding thumb print images;
a viewer folder for storing files for viewing the images; and
decryption files for decrypting the images stored in the folders.

15. A computer readable storage medium as claimed in claim 12 which comprises:
a number of room/area/category folders for storage of inventory images from corresponding rooms/areas/categories;
a thumb print folder within each of the room/area/category folders for storage of corresponding thumb print images;
an html viewer folder for storing files for viewing the images; and
decryption files for decrypting the images stored in the folders.

16. A computer-readable storage medium containing data for storing the inventory of digital images as produced by the method as claimed in claim 9.

17. A computer readable storage medium as claimed in claim 16 which comprises:
a number of room/area/category folders for storage of inventory images from corresponding rooms/areas/categories;
a thumb print folder within each of the room/area/category folders for storage of corresponding thumb print images; and
a viewer folder for storing files for viewing the images.

18. A computer readable storage medium as claimed in claim 16 which comprises:
a number of room/area/category folders for storage of inventory images from corresponding rooms/areas/categories;
a thumb print folder within each of the room/area/category folders for storage of corresponding thumb print images;
a viewer folder for storing files for viewing the images; and
decryption files for decrypting the images stored in the folders.

19. A computer readable storage medium as claimed in claim 16 which comprises:
a number of room/area/category folders for storage of inventory images from corresponding rooms/areas/categories;
a thumb print folder within each of the room/area/category folders for storage of corresponding thumb print images;
an html viewer folder for storing files for viewing the images; and
decryption files for decrypting the images stored in the folders.

20. A computer-readable storage medium containing data for storing the inventory of digital images wherein the data comprises:
a number of room/area/category folders for storage of inventory images from corresponding rooms/areas/categories;
a thumb print folder within each of the room/area/category folders for storage of corresponding thumb print images; and
a viewer folder for storing files for viewing the images.

21. A computer-readable storage medium containing data for storing the inventory of digital images as claimed in claim 20 wherein the data further comprises decryption files for decrypting the images stored in the folders.

22. A computer-readable storage medium containing data for storing the inventory of digital images as claimed in claim 21 wherein the viewing files are html files.
